(19) United States
(12) Patent Application Publication
(10) Pub. No.: US 2024/0332508 A1
(43) Pub. Date: Oct. 3, 2024

(54) Positive Electrode Active Material, All-Solid-State Battery, and Method of Manufacturing Positive Electrode Active Material

(71) Applicant: TOYOTA JIDOSHA KABUSHIKI KAISHA, Toyota-shi Aichi-ken (JP)

(72) Inventor: Masaru KUBOTA, Okazaki-shi Aichi-ken (JP)

(73) Assignee: TOYOTA JIDOSHA KABUSHIKI KAISHA, Toyota-shi Aichi-ken (JP)

(21) Appl. No.: 18/616,540

(22) Filed: Mar. 26, 2024

(30) Foreign Application Priority Data
Mar. 28, 2023 (JP) 2023-051115

(51) Int. Cl. H01M 4/36; H01M 4/02; H01M 4/62; H01M 10/0525; H01M 10/0562

(52) U.S. Cl. CPC H01M 4/366; H01M 4/62; H01M 10/0525; H01M 10/0562; H01M 2004/028; H01M 2300/0068

(57) ABSTRACT

A positive electrode active material includes: an active material particle; and a coating film. The coating film covers at least a part of a surface of the active material particle. The coating film contains P, B and O as components and further contains Li and Na as optional components. The positive electrode active material satisfies relationships of “formula (1): C_{Li}/(C_{P}+C_{B})≤1.50” and “formula (2): C_{Na}/(C_{P}+C_{B})≤1.34”. C_{Li}, C_{P}, C_{B} and C_{Na} represent respective element concentrations each measured by X-ray photoelectron spectroscopy. C_{Li} represents an element concentration of lithium. C_{P} represents an element concentration of phosphorus. C_{B} represents an element concentration of boron. C_{Na} represents an element concentration of lithium.

### CROSS REFERENCE TO RELATED APPLICATIONS

This nonprovisional application is based on Japanese Patent Application No. 2023-051115 filed on Mar. 28, 2023 with the Japan Patent Office, the entire contents of which are hereby incorporated by reference.

### BACKGROUND

### Field

The present disclosure relates to a positive electrode active material, an all-solid-state battery, and a method of manufacturing a positive electrode active material.

### Description of the Background Art

Japanese Patent Application Laid-Open No. 2003-338321 discloses forming a film of an inorganic solid electrolyte between a positive electrode material and an organic electrolyte.

### SUMMARY

A sulfide-based all-solid battery (hereinafter, also simply referred to as “all-solid-state battery”) has been developed. The all-solid-state battery includes a sulfide solid electrolyte. In a positive electrode, an active material particle has a high potential. In the positive electrode, when the sulfide solid electrolyte comes into direct contact with the active material particle, the sulfide solid electrolyte can be deteriorated. With the deterioration of the sulfide solid electrolyte (ion conduction path), battery resistance can be increased. To address this, it has been proposed to form a coating film on a surface of the active material particle. The coating film inhibits the direct contact between the active material particle and the sulfide solid electrolyte, thereby reducing the deterioration of the sulfide solid electrolyte. Conventionally, it has been proposed to form the coating film using an oxide solid electrolyte such as Li₃PO₄ (for example, see Japanese Patent Application Laid-Open No. 2003-338321).

It is an object of the present disclosure to reduce the battery resistance.

1. A positive electrode active material includes: an active material particle; and a coating film. The coating film covers at least a part of a surface of the active material particle. The coating film contains P, B and O as components and further contains Li and Na as optional components.

The positive electrode active material satisfies relationships of the following formula (1) and formula (2):

$${C}_{Li} / ( {C}_{P} + {C}_{B} ) \leq 1.5 \qquad ( 1 )$$

$${C}_{Na} / ( {C}_{P} + {C}_{B} ) \leq 1.34 \qquad ( 2 )$$

In the formula (1) and the formula (2), C_{Li}, C_{P}, C_{B} and C_{Na} represent respective element concentrations each measured by X-ray photoelectron spectroscopy. C_{Li} represents an element concentration of lithium. C_{P} represents an element concentration of phosphorus. C_{B} represents an element concentration of boron. C_{Na} represents an element concentration of sodium.

Hereinafter, the left side “C_{Li}/(C_{P}+C_{B})” of the formula (1) is also referred to as “Li composition ratio”. The left side “C_{Na}/(C_{P}+C_{B})” of the formula (2) is also referred to as “Na composition ratio”.

In Li₃PO₄, the Li composition ratio is 3. It is considered that Li in Li₃PO₄ (oxide solid electrolyte) promotes ion conduction (Li conduction). Therefore, as the Li composition ratio is larger, the battery resistance is expected to be reduced. However, contrary to the expectation, it has been found that as the Li composition ratio is smaller, the battery reduction can be reduced. Further, as indicated in the formula (1) above, it has been found that the battery resistance is significantly reduced when the Li composition ratio is 1.5 or less.

As a result of reviews on various types of phosphate compounds, it has been found that when a phosphate compound (orthophosphate) having a low polymerization degree is used as a raw material, the battery resistance is less likely to be reduced. Further, it has been also observed that when an impurity such as Na is contained in the raw material, the battery resistance tends to be less likely to be reduced. As a result, an expensive raw material (having a high polymerization degree and a high purity) has to be used.

In the positive electrode active material according to “1”, the coating film includes the composite oxide. That is, the coating film further contains B in addition to P and O. P, B and O can form a glass network. Since the glass network includes two types of anions (PO-based anion and BO-based anion), a mixed-anion effect is expected to be exhibited. With the mixed-anion effect, ion conductivity can be significantly increased.

Further, although details of mechanism are unknown, the coating film containing P, B and O can have robustness. That is, the coating film may contain Na to some extent. Even when the coating film contains Na to some extent, the battery resistance can be expected to be reduced. Further, even when a phosphate raw material having a low polymerization degree is used, the battery resistance can be expected to be reduced. Hence, use of an inexpensive raw material (having a low polymerization degree and a low purity) can be also accepted.

It should be noted that as indicated in the formula (2), the Na composition ratio is 1.34 or less. When the Na composition ratio exceeds 1.34, a desired battery resistance may be unable to be obtained even though the Li composition ratio is 1.5 or less and the coating film contains B.

2. The positive electrode active material according to “1” above may include, for example, the following configuration. The coating film contains Na as a component.

The positive electrode active material satisfies relationships of the following formula (3) and the following formula (4):

$${C}_{Li} / ( {C}_{P} + {C}_{B} ) \leq 1.27 \qquad ( 3 )$$

$$0.24 \leq {C}_{Na} / ( {C}_{P} + {C}_{B} ) \qquad ( 4 )$$

3. The positive electrode active material according to “1” or “2” may include, for example, the following configuration. The positive electrode active material has a coverage of 94% or more. The coverage is measured by the X-ray photoelectron spectroscopy. Since the coverage is 94% or more, the battery resistance is expected to be reduced.

4. An all-solid-state battery includes: a positive electrode; and a negative electrode. The positive electrode includes the positive electrode active material according to any one of “1” to “3” and a sulfide solid electrolyte.

5. A method of manufacturing a positive electrode active material includes the following (a) and (b).

(a) A mixture is prepared by mixing a coating liquid and an active material particle.

(b) The positive electrode active material is manufactured by drying the mixture.

The coating solution includes a solute and a solvent. The solute contains a phosphate compound and a borate compound as components, and contains, as an optional component, at least one selected from a group consisting of a lithium compound, a sodium salt and an ammonium salt.

Since the coating liquid contains both the phosphate compound and the borate compound, a coating film containing P, B and O can be formed. When the coating solution contains both the phosphate compound and the borate compound, a raw material containing a Na salt or NH₄ salt may be used. Even when the coating liquid contains the Na salt or NH₄ salt, the battery resistance is expected to be reduced. For example, at least a part of the phosphate compound may be the Na salt. For example, at least a part of the borate compound may be the NH₄ salt. It should be noted that Na originated from the Na salt can be contained in the coating film. N originated from the NH₄ salt can be discharged out of the system during the process of formation of the coating film.

The following describes an embodiment of the present disclosure (hereinafter, also simply referred to as “the present embodiment”) and an example of the present disclosure (hereinafter, also simply referred to as “the present example”). It should be noted that the present embodiment and the present example do not limit the technical scope of the present disclosure. The present embodiment and the present example are illustrative in any respect. The present embodiment and the present example are non-restrictive. The technical scope of the present disclosure includes any modifications within the scope and meaning equivalent to the terms of the claims. For example, it is initially expected to extract freely configurations from the present embodiment and the present example and combine them freely.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a conceptual diagram of a positive electrode active material in this embodiment.

FIG. 2 is a schematic flowchart of a method of manufacturing a positive electrode active material according to the present embodiment.

FIG. 3 is a conceptual diagram of an all-solid-state battery according to the present embodiment.

FIG. 4 is a table showing experimental results.

### DESCRIPTION OF THE EMBODIMENTS

### Description of Terms

The “element concentration (C_{Li}, C_{P}, C_{B}, C_{Na})” indicates a value measured by the following procedure. Element concentration is measured by X-ray photoelectron spectroscopy (XPS). The XPS acquires composition information of the outermost surface of the object to be measured. For example, an XPS apparatus (product name “PHI X-tool”) manufactured by Ulvac PHI and equivalents thereof may be used. The positive electrode active material (powder) is set in an XPS device. A narrow scan analysis is performed with a pass energy of 224 eV. The measurement data is processed by the analysis software. For example, analysis software fair (product name “MulTiPak”) manufactured by Ulvac PHI and equivalents thereof may be used. The peak area (integral value) of the Li1s spectrum is converted to the element concentration (C_{Li}) of Li. The peak area of the P2p spectrum is converted to the element concentration (C_{P}) of P. The peak area of the B1s spectrum is converted to the element concentration (C_{B}) of B. The peak area of the Na1s spectrum is converted to the element concentration (C_{Na}) of Na.

The “coverage” indicates a value measured in the following procedure. By analyzing the XPS data obtained above, the element concentration is obtained from each peak area of C1s, O1s, B1s, P2p, M2p3, and the like. The coverage is obtained by the following formula (5).

$$θ = ( P + B ) / ( P + B + M ) \qquad ( 5 )$$

In the above formula (5), θ represents a coverage. Coverage is expressed in percentage (%). P, B, and M represent the element concentration of each element. M represents the element concentration of the constituent element (However, Li and O are excluded.) of the active material particles. M may contain, for example, at least one selected from the group consisting of Ni, Co, Mn, and Al. For example, when the active material particles are LiNi_{1/3}Co_{1/3}Mn_{1/3}O₂, the right side of the above formula (5) can be transformed to “(P+B)/(P+B+Ni+Co+Mn)”. For example, when the active material particles are “LiNi_{0.8}Co_{0.15}Al_{0.05}O₂”, the right side of the formula (5) can be transformed to “(P+B)/(P+B+Ni+Co+Al)”.

A numerical range such as “m to n %” includes an upper limit value and a lower limit value unless otherwise specified. That is, “m to n %” indicates a numerical range of “m % or more and n % or less”. Further, “m % or more and n % or less” includes “more than m % and less than n %”.

### <Positive Electrode Active Materials>

The positive electrode active material may comprise one particle. The positive electrode active material may include two or more particles. That is, the positive electrode active material may be powder (aggregation of particles). The positive electrode active material may have a D50 of, for example, 1 to 30 μm, 10 to 20 μm, or 1 to 10 μm. “D50” represents the particle diameter at which the integration becomes 50% in the particle size distribution (integral distribution) based on the volume. The particle size distribution can be measured by laser diffraction.

FIG. 1 is a conceptual diagram of a positive electrode active material in this embodiment. The positive electrode active material 5 includes composite particles. The composite particles have a core-shell structure. That is, the positive electrode active material 5 includes the active material particles 1 and the coating film 2. The positive electrode active material 5 can be called, for example, a “coated active material”.

### <Coating Film>

The coating film 2 is a shell of the positive electrode active material 5. The coating film 2 covers at least a part of the surface of the active material particles 1 (core). The coverage may be, for example, 93% or more. The coverage may be, for example, 94% or more, 95% or more, 96% or more, or 97% or more. The coverage may be, for example, 100% or less, 97% or less, 96% or less, or 95% or less.

The thickness of the coating film 2 may be, for example, 5 to 100 nm, 5 to 50 nm, 10 to 30 nm, or 20 to 30 nm. The thickness of the coating film 2 can be measured, for example, by cross-sectional observation of composite particles. Cross-sectional observation can be performed, for example, by SEM (Scanning Electron Microscope).

The coating film 2 contains P, B and O as components. P, B and O may form oxide glass. The oxide glass may include a glass network structure. Coexistence of P and B expects the development of mixed-anion effects. The oxide glass may include, for example, a phosphate skeleton and a borate skeleton. For example, TOF-SIMS (Time-of-Flight Secondary Ion Mass Spectrometry) spectrum of the positive electrode active material 5 may include fragment peaks derived from phosphate-based ions (e.g., PO₂⁻, PO₃⁻, etc.) and fragment peaks derived from borate-based ions (e.g., BO₂⁻, BO₃⁻, etc.).

The coating film 2 optionally contains Li. Li may be a component. In the present embodiment, the relationship of the following formula (1) is satisfied.

$${C}_{Li} / ( {C}_{P} + {C}_{B} ) \leq 1.5 \qquad ( 1 )$$

When the relationship of the above formula (1) is satisfied, a reduction in battery resistance is expected. It is to be noted that two or more kinds of Li may be derived from the coating film 2. For example, the coating film 2 may contain Li derived from a lithium compound contained in the coating liquid. For example, the coating film 2 may contain Li diffused from the active material particles 1 when the coating film 2 is formed.

For example, the relationship of the following formula (3) may be satisfied.

$${C}_{Li} / ( {C}_{P} + {C}_{B} ) \leq 1.27 \qquad ( 3 )$$

The Li composition ratio may be, for example, 1.11 or less, 1.01 or less, 1.00 or less, 0.89 or less, 0.82 or less, or 0.5 or less. The Li composition ratio may be, for example, 0.5 or more, 0.82 or more, 0.89 or more, 1.00 or more, 1.01 or more, 1.11 or more, or 1.27 or more.

The quantitative relationship between P and B is arbitrary as long as the relationship of the above formula (1) is satisfied. For example, the relationship of “C_{P}/C_{B}=99/1 to 1/99”, “C_{P}/C_{B}=9/1 to 1/9” or “C_{P}/C_{B}=7/3 to 3/7” may be satisfied. For example, a relationship such as “1≤C_{P}/C_{B}” or “2≤C_{P}/C_{B}” may be satisfied.

The coating film 2 further contains Na as an optional component. Na may be a component. In the present embodiment, the relationship of the following formula (2) is satisfied.

$${C}_{Na} / ( {C}_{P} + {C}_{B} ) \leq 1.34 \qquad ( 2 )$$

When the Na composition ratio exceeds 1.34, for example, there is a possibility that a disadvantage such as an increase in battery resistance may occur. The Na composition ratio may be, for example, 0.84 or less, 0.61 or less, 0.43 or less, 0.37 or less, 0.27 or less, 0.24 or less, or 0.05 or less.

For example, the relationship of the following formula (4) may be satisfied.

$$0.24 \leq {C}_{Na} / ( {C}_{P} + {C}_{B} ) \qquad ( 4 )$$

The Na composition ratio may be, for example, 0.05 or more, 0.27 or more, 0.37 or more, 0.43 or more, 0.61 or more, or 0.84 or more.

### <Active Material Particles>

The active material particles 1 are cores of the positive electrode active material 5. The active material particles 1 may have a D50 of, for example, 1 to 30 μm, 10 to 20 μm, or 1 to 10 μm. The active material particles 1 can reversibly store Li ions. The active material particles 1 may have any crystal structure. The active material particles 1 may include, for example, a lamellar rock salt structure.

The active material particles 1 may have any composition. The active material particles 1 may have, for example, a composition represented by the following formula (6).

Li₁₋ₐNiₓM₁₋ₓO₂ (6)

In the above formula (6), the relationship of −0.5≤a≤0.5 and 0<x<1 is satisfied. M is at least one kind selected from the group consisting of Co, Mn and Al. For example, a relationship of 0.5≤x<1, or 0.6≤x<0.9 may be satisfied.

A dopant may be added to the active material particles 1. The dopant may diffuse throughout the particle or may be locally distributed. For example, the dopant may be unevenly distributed on the particle surface. The dopant may be a substitutional solid solution atom or an interstitial solid solution atom. The amount of dopant added (molar fraction with respect to the whole active material particles 1) may be, for example, 0.01 to 5%, 0.1 to 3%, or 0.1 to 1%. The dopant may include, for example, at least one selected from the group consisting of B, C, N, halogen, Si, Na, Mg, Al, Mn, Co, Cr, Sc, Ti, V, Cu, Zn, Ga, Ge, Se, Sr, Y, Zr, Nb, Mo, In, Pb, Bi, Sb, Sn, W, La, Ce, Pr, Nd, Pm, Sm, Eu, Gd, Tb, Dy, Ho, Er, Tm, Yb, Lu, and actinoids.

### <Method for Manufacturing Positive Electrode Active Material>

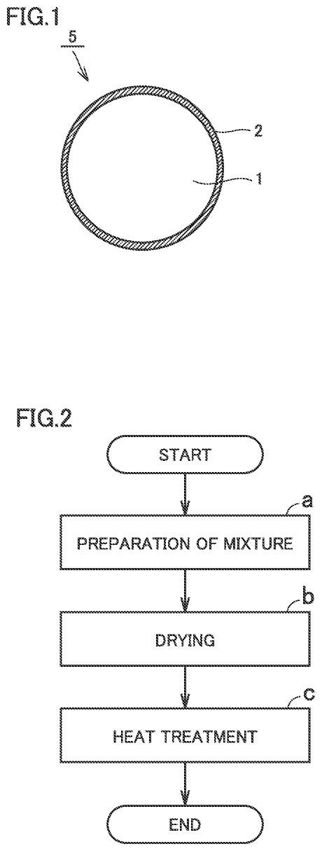

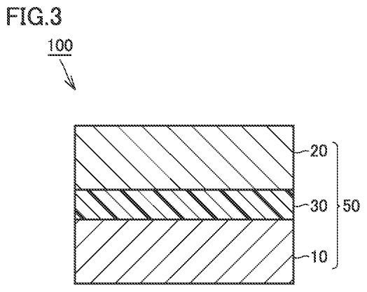

FIG. 2 is a schematic flowchart of a method of manufacturing a positive electrode active material according to the present embodiment. Hereinafter, the “method of manufacturing a positive electrode active material in the present embodiment” may be abbreviated as “the present production method”. The manufacturing method includes “(a) preparation of mixture” and “(b) drying”. The manufacturing method may further include, for example, “(c) heat treatment” or the like.

### <(a) Preparation of Mixture>

The manufacturing method includes mixing a coating liquid and active material particles 1 to prepare a mixture. The details of the active material particles 1 are as described above. The mixture may be either a suspension or a wet powder, for example. For example, a suspension may be formed by dispersing the active material particles 1 (powder) in the coating liquid. For example, a wet powder may be formed by spraying a coating liquid into the powder. In the present manufacturing method, any mixing device, granulation device, or the like may be used.

The coating solution includes a solute and a solvent. The coating solution may further include, for example, a suspension (insoluble component), a precipitate, and the like. The solvent may include any component so long as the solute can dissolve. The solvent may include, for example, water, alcohol, etc. The solvent may include, for example, ion-exchanged water, methanol, ethanol, etc.

The solute contains a raw material of the coating film 2. The blending amount of the solute may be, for example, 0.1 to 20 parts by mass with respect to 100 parts by mass of the solvent. The solute contains a phosphate compound and a borate compound as components. The phosphate compound is the P source of the coating film 2. The borate compound is the B source of the coating film 2. The solute optionally contains at least one selected from the group consisting of a lithium compound, a Na salt, and an NH₄ salt. For example, the solute may consist of phosphate and borate. For example, the solute may contain phosphate and borate, and may further contain Na phosphate, Na borate, NH₄ phosphate, NH₄ borate, and the like. The Na phosphate or the like may act as, for example, an excipient. In the solute, all or a part of the phosphate compound and the borate compound may form Na salt, NH₄ salt, or the like. By replacing all or a part of the raw material with a Na salt or the like, it is expected to reduce the raw material cost. For example, a mixture of metaphosphate and Na orthophosphate may be used. For example, in the condensed phosphate (metaphosphate or the like), all or a part of the phosphate groups may form a Na salt or the like. The phosphate compound may contain, for example, orthophosphate or the like. By using a phosphate compound having a low degree of polymerization, it is expected that the raw material cost is reduced. The solute may contain, for example, at least one selected from the group consisting of orthophosphate, polyphosphate, metaphosphate, Na orthophosphate, Na polyphosphate, Na metaphosphate, Na hexametaphosphate, 2Na phosphate, 3Na phosphate, borate, Na metaborate, and NH₄ borate. The Na and NH₄ salts may be, for example, hydrates.

The solute may contain a lithium compound as long as the Li composition ratio of the positive electrode active material 5 can be 1.5 or less. The lithium compound may contain, for example, lithium hydroxide, lithium nitrate, lithium carbonate, or the like.

### <(b) Drying>

The manufacturing method includes manufacturing the positive electrode active material 5 by drying the mixture. The coating liquid adhered to the surface of the active material particles 1 is dried to form the coating film 2. In the present manufacturing method, any drying method may be used. For example, the mixture may be dried by a spray dryer. That is, droplets are formed by spraying the suspension from the nozzle. The droplet contains active material particles 1 and a coating liquid. For example, the positive electrode active material 5 may be formed by drying droplets by hot air. By using the spray dry method, for example, an improvement in coverage is expected.

For example, the positive electrode active material 5 may be produced by a rolling fluidized bed coating apparatus. In a rolling fluidized bed coating apparatus, “(a) preparation of mixture” and “(b) drying” may proceed substantially simultaneously.

### <(c) Heat Treatment>

The manufacturing method may include subjecting the positive electrode active material 5 to a heat treatment. The coating film 2 can be fixed by heat treatment. The heat treatment may also be referred to as “calcination”. In the present manufacturing method, any heat treatment apparatus may be used. The processing temperature may be, for example, 150 to 300° C. The treatment time may be, for example, 1 to 10 hours. The heat treatment atmosphere may be, for example, an air atmosphere or an inert atmosphere.

### <All-Solid-State Battery>

FIG. 3 is a conceptual diagram of an all-solid-state battery according to the present embodiment. Battery 100 may have any profile. The battery 100 may have, for example, a plate-like outer shape. The battery 100 includes a power generation element 50. The battery 100 may include an exterior body (not shown). The exterior body may house the power generation element 50. The exterior body may be, for example, an Al laminate film pouch or the like. The power generation element 50 includes a positive electrode 10 and a negative electrode 20. The power generation element 50 may further comprise a separator layer 30. The separator layer 30 is disposed between the positive electrode 10 and the negative electrode 20. The power generation element 50 may have any form. The power generation element 50 may have either a monopolar structure or a bipolar structure, for example.

The positive electrode 10 may include, for example, a positive electrode current collector and a positive electrode active material layer. The positive electrode current collector may include, for example, an Al foil or the like. The positive electrode active material layer is disposed on the surface of the positive electrode current collector. The positive electrode active material layer includes a positive electrode active material and a sulfide solid electrolyte. The details of the positive electrode active material are as described above.

The blending amount of the sulfide solid electrolyte may be, for example, 1 to 200 parts by volume based on 100 parts by volume of the positive electrode active material. The sulfide solid electrolyte may be, for example, either glass ceramics or argyrodite. The sulfide solid electrolyte may include, for example, at least one selected from the group consisting of LiI—LiBr—Li₃PS₄, Li₂S—SiS₂, LiI—Li₂S—SiS₂, LiI—Li₂S—P₂S₅, LiI—Li₂O—Li₂S—P₂S₅, LiI—Li₂S—P₂O₅, LiI—Li₃PO₄—P₂S₅, Li₂S—GeS₂—P₂S₅, Li₂S—P₂S₅, Li₁₀GeP₂S₁₂, Li₄P₂S₆, Li₇P₃S₁₁, Li₃PS₄, Li₇PS₆, and Li₆PS₅X (X=Cl, Br, I).

For example, “LiI—LiBr—Li₃PS₄” represents a sulfide solid electrolyte produced by mixing LiI, LiBr and Li₃PS₄ at an arbitrary molar ratio. For example, a sulfide solid electrolyte may be produced by a mechanochemical method. The mixing ratio may be identified by numbering before each raw material. For example, “10LiI-15LiBr-75Li₃PS₄” indicates that the mixture ratio of raw materials is “LiI/LiBr/Li₃PS₄=Oct. 15, 1975 (molar ratio)”.

The positive electrode active material layer may further include, for example, a conductive material, a binder, and the like. The blending amount of the conductive material and the binder may be, for example, 0.1 to 10 parts by mass with respect to 100 parts by mass of the positive electrode active material. The conductive material may include, for example, acetylene black, vapor grown carbon fiber (VGCF), etc. The binder may include, for example, polyvinylidene difluoride (PVDF), styrene-butadiene rubber (SBR), or the like.

### EXAMPLES

### <Samples>

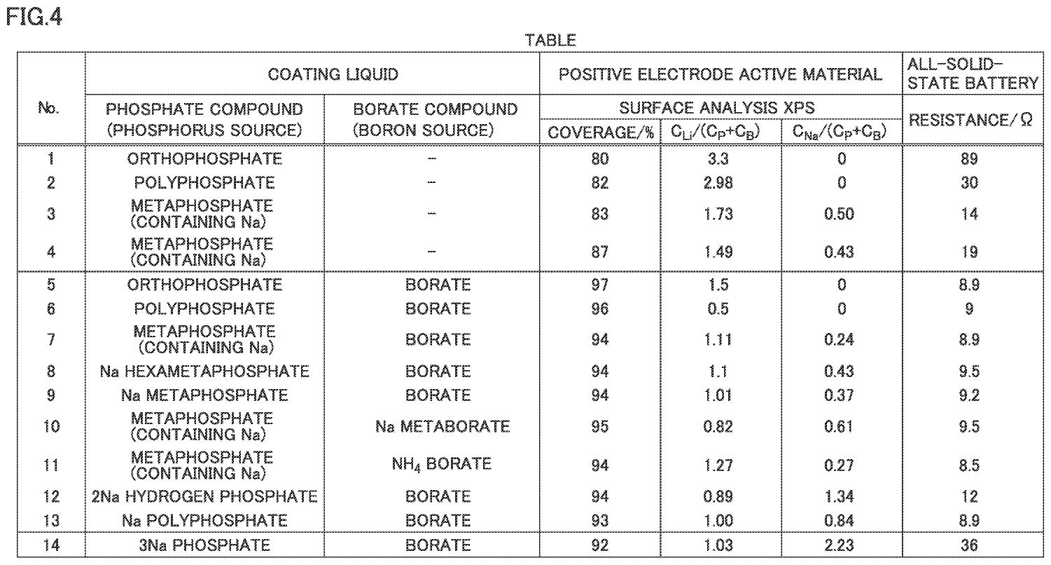

FIG. 4 is a table showing experimental results. A positive electrode active material and an all-solid-state battery according to Nos. 1 to 14 were produced as follows.

### No. 1

A coating solution was prepared by dissolving 10.8 parts by mass of orthophosphate (containing 85%, manufactured by Kishida Chemical) in 166 parts by mass of ion-exchanged water.

A suspension was prepared by dispersing 50 parts by mass of active material particles (LiNi_{1/3}Co_{1/3}Mn_{1/3}O₂) in 53.7 parts by mass of a coating liquid. A positive electrode active material was produced by supplying the suspension to a spray dryer (Product name “Mini Spray Dryer B-290”, manufactured by BUCHI). The air supply temperature of the spray dryer was 200° C., and the air supply air volume was 0.45 m³/min. The positive electrode active material was heat treated in air. The heat treatment temperature was 200° C.

A positive electrode slurry was prepared by mixing a positive electrode active material, a sulfide solid electrolyte (10LiI-15LiBr-75Li₃PS₄), a conductive material (VGCF), a binder (SBR), and a dispersion medium (heptane). The mixture ratio of the positive electrode active material and the sulfide solid electrolyte was “positive electrode active material/sulfide solid electrolyte=6/4 (volume ratio)”. The blending amount of the conductive material and the binder was 3 parts by mass with respect to 100 parts by mass of the positive electrode active material. The positive electrode slurry was sufficiently stirred by the ultrasonic homogenizer. The positive electrode slurry was coated on the surface of the positive electrode current collector (Al foil) to form a coating film. The coating was dried on a hot plate at 100° C. for 30 minutes. Thus, a positive electrode raw material was produced. A disc-shaped positive electrode was cut out from the positive electrode raw material. The area of the positive electrode was 1 cm².

A negative electrode and a separator layer were prepared. The negative electrode active material was graphite. The same type of sulfide solid electrolyte was used between the positive electrode, the separator layer, and the negative electrode. In the cylindrical jig, the positive electrode, the separator layer, and the negative electrode were stacked in this order to form a stack. The stack was pressed to form a power generation element. An all-solid-state battery was formed by connecting terminals to the power generation element.

### No. 2

A positive electrode active material and an all-solid-state battery were produced in the same manner as in No. 1 except that polyphosphate (product name: “polyphosphate-116T”, manufactured by Nippon Chemical Industrial) was used instead of orthophosphate.

### No. 3 and No. 4

A coating solution was prepared by dissolving 10.8 parts by mass of metaphosphate (containing Na) (manufactured by FUJIFILM Wako Pure Chemical Corporation) in 166 parts by mass of ion-exchanged water. Except for this, similarly to No. 1, the positive electrode active material and all-solid-state battery according to No. 3 and No. 4 were manufactured, respectively. The term “metaphosphate (containing Na)” denotes a mixture of metaphosphate and sodium metaphosphate (excipient). The molar ratio “Na/P” in metaphosphate (containing Na) was 0.5. The molar ratio “Na/P” indicates the ratio of the amount of substance of Na to the amount of substance of P.

### No. 5

A solution was formed by dissolving 10.8 parts by mass of orthophosphate (containing 85%, manufactured by Kishida Chemical) in 166 parts by mass of ion-exchanged water. Further, borate (manufactured by NACALAI TESQUE) was dissolved in the solution so that the molar ratio “P/B” became 1.0 to prepare a coating solution. Except for this, a positive electrode active material and an all-solid-state battery were produced in the same manner as in No. 1. The molar ratio “P/B” indicates the ratio of the amount of substance of P to the amount of substance of B.

### No. 6

A positive electrode active material and an all-solid-state battery were produced in the same manner as in No. 5, except that polyphosphate (product name: “polyphosphate-116T”, manufactured by Nippon Chemical Industrial) was used instead of orthophosphate.

### No. 7

A positive electrode active material and an all-solid-state battery were produced in the same manner as in No. 5, except that metaphosphate (containing Na) (manufactured by FUJIFILM Wako Pure Chemical Corporation) was used instead of orthophosphate.

### No. 8

A positive electrode active material and an all-solid-state battery were produced in the same manner as in No. 5, except that sodium hexametaphosphate (manufactured by Yoneyama Chemical Industrial Co., Ltd.) was used instead of orthophosphate.

### No. 9

A positive electrode active material and an all-solid-state battery were produced in the same manner as in No. 5, except that sodium metaphosphate (manufactured by FUJIFILM Wako Pure Chemical Corporation) was used instead of orthophosphate.

### No. 10

A positive electrode active material and an all-solid-state battery were produced in the same manner as in No. 5, except that sodium metaborate (manufactured by Yoneyama Chemical Industrial Co., Ltd.) was used instead of borate.

### No. 11

A positive electrode active material and an all-solid-state battery were produced in the same manner as in No. 5, except that ammonium borate (manufactured by Yoneyama Chemical Industrial Co., Ltd.) was used instead of borate.

### No. 12

A positive electrode active material and an all-solid-state battery were produced in the same manner as in No. 5, except that disodium hydrogen phosphate dodecahydrate (manufactured by FUJIFILM Wako Pure Chemical Corporation) was used instead of orthophosphate. The molar ratio “Na/P” in disodium hydrogen phosphate dodecahydrate was 2.0.

### No. 13

A positive electrode active material and an all-solid-state battery were produced in the same manner as in No. 5, except that sodium polyphosphate (manufactured by FUJIFILM Wako Pure Chemical Corporation) was used instead of orthophosphate. The molar ratio “Na/P” in the sodium polyphosphate was 1.0.

### No. 14

A positive electrode active material and an all-solid-state battery were produced in the same manner as in No. 5, except that trisodium phosphate dodecahydrate (manufactured by FUJIFILM Wako Pure Chemical Corporation) was used instead of orthophosphate. The molar ratio “Na/P” in trisodium phosphate dodecahydrate was 3.0.

### <Evaluation>

The Li composition ratio, the Na composition ratio, and the coverage rate of each positive electrode active material were measured by an XPS apparatus. Resistance was measured in each all-solid-state battery. The measurement results are shown in FIG. 4.

### <Results>

When the Li composition ratio “C_{Li}/(C_{P}+C_{B})” is 1.5 or less, the battery resistance tends to be significantly reduced. Further, in a range in which the Na composition ratio “C_{Na}/(C_{P}+C_{B})” is equal to or less than 1.34, there is a tendency to stabilize at a low battery resistance value (No. 5 to No. 13).

When the coating film does not contain B, even when the Li composition ratio is 1.5 or less and the Na composition ratio is 1.34 or less, the battery resistance tends to be high (No. 4).

Even if the coating film contains B and the Li composition ratio is 1.5 or less, if the Na composition ratio exceeds 1.34, the battery resistance tends to be high (No. 14).

What is claimed is:

1. A positive electrode active material comprising:
an active material particle; and
a coating film, wherein
the coating film covers at least a part of a surface of the active material particle,
the coating film contains P, B and O as components and further contains Li and Na as optional components,
the positive electrode active material satisfies relationships of the following formula (1) and formula (2):
$${C}_{Li} / ( {C}_{P} + {C}_{B} ) \leq 1.5 \qquad ( 1 )$$
$${C}_{Na} / ( {C}_{P} + {C}_{B} ) \leq 1.34 , \qquad ( 2 )$$
in the formula (1) and the formula (2),
C_{Li}, C_{P}, C_{B} and C_{Na} represent respective element concentrations each measured by X-ray photoelectron spectroscopy, and
C_{Li} represents an element concentration of lithium, C_{P} represents an element concentration of phosphorus, C_{B} represents an element concentration of boron, and C_{Na} represents an element concentration of sodium.

2. The positive electrode active material according to claim 1, wherein
the coating film contains Na as a component, and
the positive electrode active material satisfies relationships of the following formula (3) and formula (4):
$${C}_{Li} / ( {C}_{P} + {C}_{B} ) \leq 1.27 \qquad ( 3 )$$
$$0.24 \leq {C}_{Na} / ( {C}_{P} + {C}_{B} ) . \qquad ( 4 )$$

3. The positive electrode active material according to claim 1, wherein the positive electrode active material has a coverage of 94% or more, and
the coverage is measured by the X-ray photoelectron spectroscopy.

4. An all-solid-state battery comprising:
a positive electrode; and
a negative electrode, wherein
the positive electrode includes the positive electrode active material according to claim 1 and a sulfide solid electrolyte.

5. A method of manufacturing a positive electrode active material, the method comprising:
(a) preparing a mixture by mixing a coating liquid and an active material particle; and
(b) manufacturing the positive electrode active material by drying the mixture, wherein
the coating liquid includes a solute and a solvent, and
the solute contains a phosphate compound and a borate compound as components, and contains, as an optional component, at least one selected from a group consisting of a lithium compound, a sodium salt and an ammonium salt.
